(19) United States
(12) Patent Application Publication
(10) Pub. No.: US 2012/0097570 A1
(43) Pub. Date: Apr. 26, 2012

(54) VACUUM CHAMBERS FOR FLYWHEELS

(75) Inventors: John Michael Pinneo, Portola Valley, CA (US); Jonathan Forrest Garber, Hillsborough, CA (US)

(73) Assignee: SPINLECTRIX INC., Hillsborough, CA (US)

(21) Appl. No.: 13/280,132

(22) Filed: Oct. 24, 2011

Related U.S. Application Data
(60) Provisional application No. 61/406,107, filed on Oct. 22, 2010.
(60) Provisional application No. 61/406,103, filed on Oct. 22, 2010.
(60) Provisional application No. 61/406,102, filed on Oct. 22, 2010.
(60) Provisional application No. 61/406,105, filed on Oct. 22, 2010.
(60) Provisional application No. 61/406,099, filed on Oct. 22, 2010.
(60) Provisional application No. 61/406,104, filed on Oct. 22, 2010.

(51) Int. Cl. B65D 81/00; C23C 4/12; B05D 5/00; B05D 7/22

(52) U.S. Cl. 206/524.2; 427/230; 427/181; 427/446; 427/457

(57) ABSTRACT

This invention is improved vacuum chambers and vacuum chamber materials for application to flywheels. The vacuum chamber includes a concrete vessel or enclosure on which a gas impermeable layer is formed.

### CROSS-REFERENCE TO RELATED APPLICATIONS

This application claims priority to U.S. Provisional Application 61/406,103 filed Oct. 22, 2010, entitled “Methods for Stabilization of Flywheels,” U.S. Provisional Application 61/406,102 filed Oct. 22, 2010, entitled “Method of Stabilization of Rotating Machinery,” U.S. Provisional Application 61/406,105 filed Oct. 22, 2010, entitled “Permanent Magnets for Flywheels,” U.S. Provisional Application 61/406,099 filed Oct. 22, 2010, entitled “Flywheel Structures,” U.S. Provisional Application 61/406,104 filed Oct. 22, 2010, entitled “Kinetic Energy Storage Rotor Design,” and U.S. Provisional Application 61/406,107 filed Oct. 22, 2010, entitled “Concrete Vacuum Enclosures for Energy Storage Flywheels.” Each of these references are incorporated herein by reference in their entirety.

### BACKGROUND OF THE INVENTION

1. The Field of the Invention

The present invention relates to rotating machinery. More particularly, the present invention relates to vacuum chambers and chamber materials for application to flywheels.

2. The Relevant Technology

Flywheels have long been used for energy storage. In order to work properly, it is necessary for the flywheels to rotate at high speeds. Unfortunately, the flywheels are subject to energy loss through aerodynamic drag effects. In order to alleviate this drag, it is common in energy storage flywheel systems to operate the flywheel inside a chamber from which gases are substantially excluded in order to mitigate energy loss.

Vacuum chambers for use with energy storage flywheels are frequently made of metals like aluminum, stainless steel, or the like because metals can provide adequate strength to withstand differential pressure between an evacuated interior and the surrounding atmosphere, as well as provide a barrier to the passage of atmospheric gases through the chamber wall by diffusion or flow through structural defects.

Another desirable aspect of flywheel vacuum chambers made from metal is their ability to contain debris in the event of a destructive disintegration of the flywheel.

FIG. 1 depicts schematically a flywheel within a vacuum chamber made using metallic materials according to the prior art. Vacuum chamber 1 is shown in magnified section view 6, enclosing flywheel components including a rotor 5, an integrated bearing motor/generator 3, a bearing assembly 4, and structural supports 2. Depicted schematically is at least one means of access 12 to the interior of the chamber 1. As may be understood by one of skill in the art, the flywheel communicates with exterior components using the means of access 12. As shown in the sectional view 6 of FIG. 1, in the vacuum chambers 1 of the prior art comprise a single metallic layer, which must be structurally sound enough to contain debris in the event of a destructive disintegration of the flywheel in addition to be as impermeable to atmospheric gasses as possible.

Unfortunately, manufacturing flywheel vacuum chambers made from metal is expensive, which can greatly restrict the range of applications for which flywheels may be economically employed. Additionally, when the vacuum chambers are made from metal, efforts must be undertaken to limit the energy loss to eddy currents generated by stray magnetic fields within the chambers.

On the other hand, vacuum chambers manufactured from composite materials such as fiber-reinforced plastics (FRP) are known, but are infrequently used and are rarely if ever employed as vacuum chambers for flywheels due to adverse gas evolution properties and in some cases, high materials and fabrication costs.

Other materials such as glass and unreinforced plastics like Lexan are also known as materials used for the manufacture of vacuum chambers, but do not offer adequate strength for debris containment and hence are not employed in vacuum chambers for use with flywheels except for relatively small units that operate in restricted research and development environments.

Although concrete has been used as a barrier material to surround a vacuum chamber within which a flywheel is operated, it has not been used as a material for fabrication of the vacuum chamber itself. One of the very few examples of use of concrete as a material for vacuum chambers is found in U.S. Patent Application Publication No. 2010/0021273 A1 by Polyak, et al., in which a concrete material composition is used in a vacuum chamber for semiconductor fabrication processes. This application restricts its invention to embodiments comprising processing regions within which substrate processing operations are performed, and does not teach towards the use of concrete vacuum chambers for other than limited substrate processing operations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to vacuum chambers and chamber materials for application to flywheels.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A first aspect of the invention is a vacuum chamber for enclosing a flywheel. The vacuum chamber comprises an evacuable vessel comprised of a material selected from the classes of materials comprising concrete and a gas impermeable layer formed on at least one of an interior surface and an exterior surface of the evacuable vessel. The flywheel is housed within the evacuable vessel and the gas impermeable layer.

A second aspect of the invention comprises a method for forming the vacuum chamber described above. As may be understood by one of ordinary skill in the art, the use of concrete as a material for the construction of an evacuable chamber for use with flywheels would meet a long-felt need in the art, and would confer a range of useful improvements to the art. Among those improvements over the prior art are reduction of costs, an increase in the range of suppliers and fabricators of suitable flywheel vacuum chambers, and an improved damage containment capability in the event of flywheel failure.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a cross section of a metallic enclosure for a flywheel as is currently known in the art;

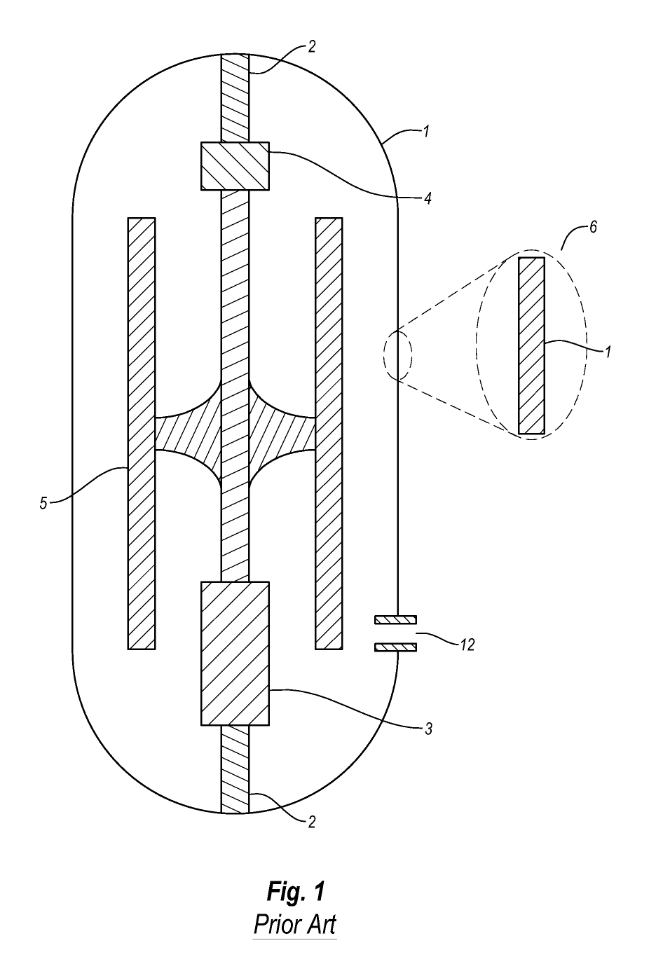

FIG. 2 is a cross section of a vacuum enclosure for a flywheel according to one embodiment of the invention;

FIG. 3 is a block diagram illustrating a method for forming a vacuum concrete enclosure for a flywheel according to one embodiment;

FIG. 4 is a block diagram illustrating a method for enclosing a flywheel using the vacuum concrete enclosure formed according to one embodiment; and

FIG. 5 is a cross section of a vacuum enclosure for a flywheel according to a second embodiment of the invention.

### DETAILED DESCRIPTION OF THE PREFERRED EMBODIMENTS

Embodiments of the invention relate to a vessel and chamber for housing a flywheel structure. More particularly, embodiments described herein relate to improved vacuum chambers and improved vacuum chamber materials which provide both durability and reduced production costs.

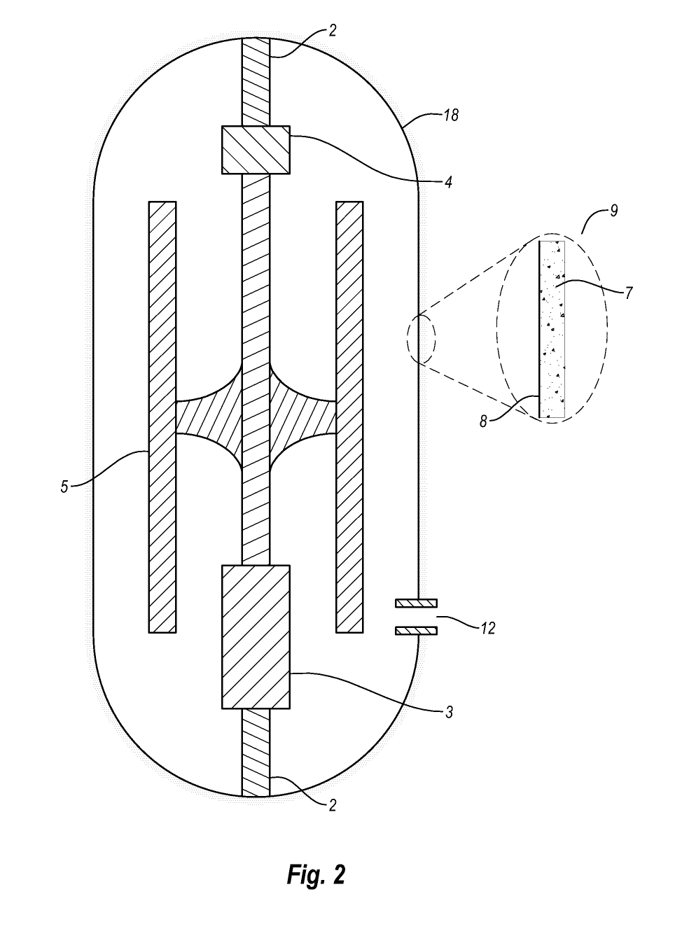

FIG. 2 depicts schematically a flywheel 15 within a vacuum chamber 10. The vacuum chamber 10 has an outer wall 18 formed of concrete 7 in combination with a thin inner gas blocking barrier 8 as depicted in magnified view 9. Flywheel 15 components include rotor 5, an integrated bearing motor/generator 3, a bearing assembly 4, and structural supports 2. Depicted schematically is at least one means of access to the interior of the chamber 12. As described more fully below, once the flywheel 15 components are assembled within the vacuum chamber via the means of access, the chamber 10 is sealed. As may be understood by one of ordinary skill in the art, other means of access 12 may exist which enable the flywheel components 15 to communicate with external components, including, but not limiting a computer including a processing unit which is able to send and receive communications with the flywheel components 15 in order to control or operate the flywheel components 15.

As shown in FIG. 2, the outer layer 7 of the wall 18 of the vacuum chamber 10 is fabricated from a material principally consisting of concrete, which material may include additives to enhance its strength, toughness, or other property. Said vacuum chamber 10 is formed according to the requirements of the flywheel 15 that is to be disposed therein, and in accord with the need to provide an evacuable chamber 10 wherein the flywheel 15 can operate with substantially reduced energy loss due to aerodynamic drag. As described below, means are provided to block the movement of external gases into the evacuated chamber, including the thin inner gas blocking barrier 8.

In one preferred embodiment, one of a class of concrete materials which may be used as the concrete layer 7 comprises Gunnite, although a variety of concrete materials may be used to form the concrete layer.

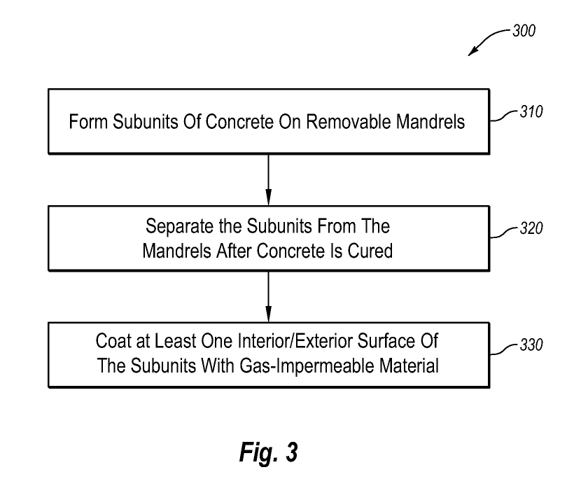

FIG. 3 is a block diagram of a method for forming wall 18 the vacuum chamber 10 of FIG. 2. As shown in FIG. 3, the process begins at step 310 where Gunnite or other concrete material is disposed on removable mandrels to form subunits of the vacuum chamber 10. In this embodiment, Gunnite is applied to the removable mandrels until a minimum section thickness of three inches is achieved. During this process, components including but not limited to feedthroughs for liquids, gases, electricity, data, or control effectors, and/or fittings for mechanical attachment of components to the interior and/or the exterior surfaces of the concrete subunits and/or ports for maintenance work or access to the interior of the chamber may be incorporated into the Gunnite as it is being applied, and are fixed into their desired positions as the Gunnite structure hardens. Then, at step 320, after the Gunnite or concrete has been adequately cured, the subunits are separated from their removable mandrels.

After separation from their removable mandrels, at step 330, the Gunnite subunits comprising the outer layer 7 are coated on their vacuum-facing surfaces with a gas-impermeable elastomeric coating such as Torr-Seal, available from Agilent Technologies or Lexington, Mass., or its distributors, to provide a barrier to the movement of atmospheric gases into the evacuated interior of the chamber 10. The gas-impermeable elastomeric coating forms the thin inner gas blocking barrier 8.

It will be apparent to those skilled in the art that the adhesion strength of the bond between the elastomer layer 8 and the adhesion of the adjacent concrete surface 7 may be adequate to prevent separation of the elastomer layer 8 and the concrete 7 in the event gases from the exterior atmosphere move through the concrete 7 and exert pressure on the adhered elastomer layer 8.

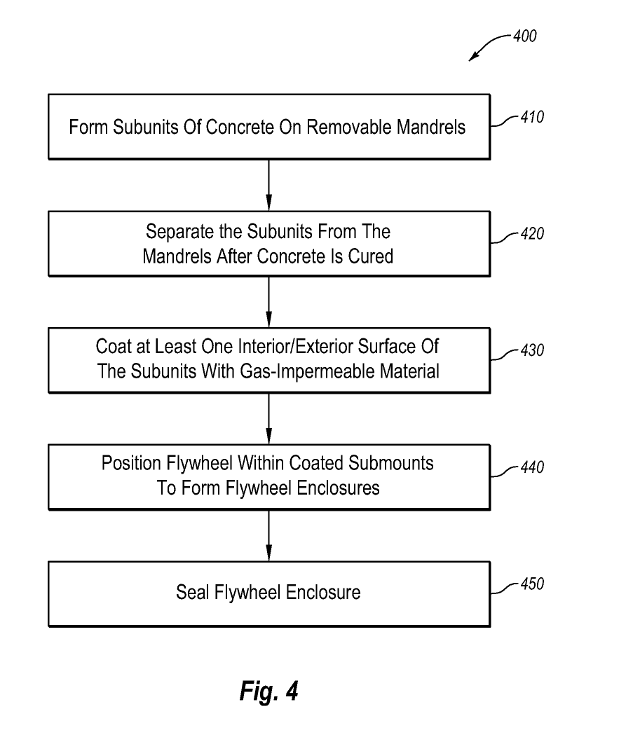

FIG. 4 is a block diagram illustrating a method of enclosing a flywheel 15. After forming the subunit enclosure according to the method described in FIG. 4 at steps 410-430 and after required curing time and/or procedures, at step 440 the concrete subunits are positioned so that the flywheel 15 and its ancillary components may be affixed to the interior of a concrete subunit or set of subunits. Subsequently, at step 450, the remaining concrete subunits are joined and sealed to their corresponding subunit or subunits so as to provide an integral evacuable chamber 10 with a flywheel 15 disposed therein.

During the sealing process, a vacuum pump may be connected to a gas feedthrough that communicates with the evacuable interior of the vacuum chamber 10. The chamber is evacuated to a desired test pressure, in this embodiment 1 milliTorr. The feedthrough is then closed and the vacuum chamber 10 may thereafter be subjected to leak tests and outgassing procedures well-known to the art. It will be noted by those skilled in the art that evacuation of the chamber 10 exerts a substantially compressive stress on the concrete, which is the stress state for which concrete is particularly well-adapted.

As briefly described above, the example of Gunnite as the concrete material is not limiting, and the concrete material may comprise one or more of materials selected from the broad class of concrete materials, including cement, that are suitable for the particular needs of the application.

Furthermore, it is contemplated that additional materials other than concrete may be incorporated into the concrete to provide a desired property or enhance an existing property. This invention contemplates addition of reinforcing materials such as wire and wire mesh, fiber-based cloth, non-oriented fibers, chopped fibers, microspheres, and particulate reinforcement materials from among the range of materials known to alter the properties of concrete.

This invention also contemplates the use of additives to provide a favorable modification of gas transport properties of the concrete, including materials that reduce or block the movement of gases through concrete by filling pores within the concrete, which are known to provide passages for gas movement according to the work of Odeh, et al., “Gas Transport Through Concrete Slabs”, Building and Environment 41, pp. 492-500 (2006).

This invention further contemplates the use of gas barrier materials other than elastomers, alone or in combination with elastomers, such materials including metals, glasses, plastics, and/or ceramics applied by plasma or flame spraying means or applied by vapor or ion deposition means, or applied by powder coating and fusing means, or other means known to the art of formation of adherent layers of such materials.

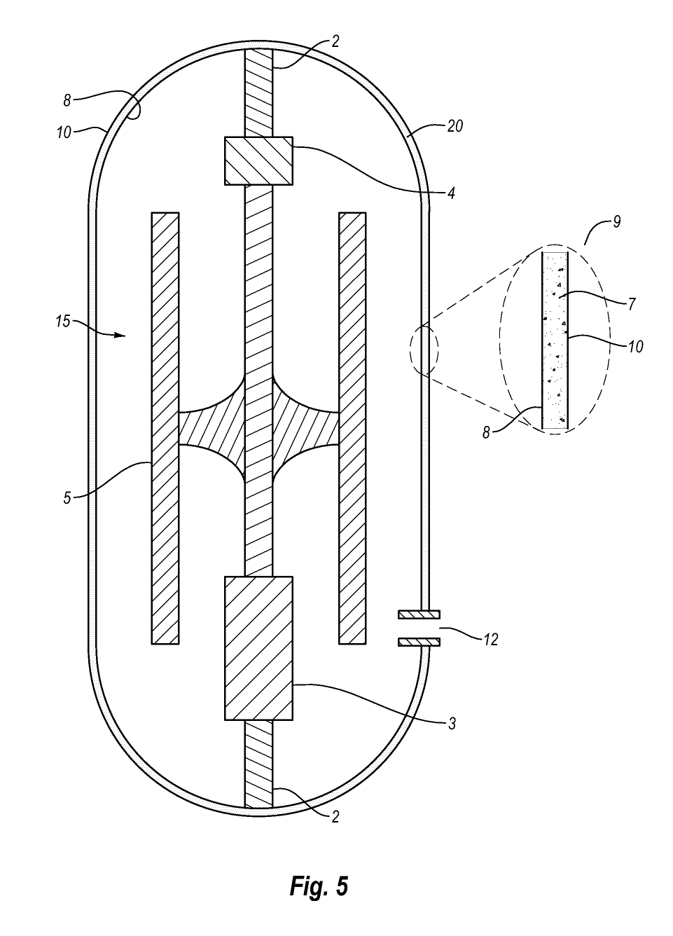

This invention further contemplates disposition of a gas barrier layer on the concrete surface adjacent to the atmosphere alone or in combination with a gas barrier layer on the concrete surface adjacent to the evacuated interior. This embodiment is illustrated in FIG. 5, which depicts schematically a flywheel 15 within a vacuum chamber 10 with a wall 18 including a layer of concrete 7 in combination with a thin inner gas blocking barrier 8 and in combination with an outer layer 10. The outer layer 10 has at least one property drawn from the following: reduced permeability to the movement of gases; resistance to incidental mechanical damage; exhibiting a desirable aesthetic property. As with FIG. 2, the vacuum chamber 10 is shown in magnified section view 11, enclosing flywheel components 15 including a rotor 5, an integrated bearing motor/generator 3, a bearing assembly 4, and structural supports 2. Depicted schematically is at least one means of access 12 to the interior of the chamber 15.

Although the embodiments described herein illustrate configurations where the chamber 10 contains one flywheel, the present invention contemplates chamber configurations that contain more than one flywheel 15.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A vacuum chamber for enclosing a flywheel, the vacuum chamber comprising:
an evacuable vessel comprised of a material selected from the classes of materials comprising concrete; and
a gas impermeable layer formed on at least one of an interior surface and an exterior surface of the evacuable vessel,
wherein the flywheel is housed within the evacuable vessel and the gas impermeable layer.

2. The vacuum chamber of claim 1, wherein the material of the evacuable vessel also comprises a metal, ceramic, glass, or plastic material.

3. The vacuum chamber of claim 1, wherein the material of the evacuable vessel comprises Gunnite.

4. The vacuum chamber of claim 1, wherein the gas impermeable layer is formed on both the interior surface and exterior surface of the evacuable vessel.

5. The vacuum chamber of claim 1, wherein the gas impermeable layer is comprised of an elastomer, metal, glass, plastic, or ceramic.

6. The vacuum chamber of claim 1, wherein an adhesion strength of a bond between the gas impermeable layer and the at least one of the interior surface and exterior surface of the evacuable vessel on which the gas impermeable layer is formed is sufficient so as to prevent separation of the gas impermeable layer and the evacuable layer when atmospheric gasses exert pressure on the gas impermeable layer.

7. A method for forming a vacuum chamber for enclosing a flywheel, the method comprising:
forming an evacuable vessel comprised of a material selected from the classes of materials comprising concrete; and
forming a gas impermeable layer on at least one of an interior surface and an exterior surface of the evacuable vessel.

8. The method of claim 7, wherein the forming the evacuable vessel comprises forming a subunit of the concrete material on a removable mandrel, curing the subunit of the concrete material, and removing the removable mandrel.

9. The method of claim 7, wherein the material of the evacuable vessel also comprises a metal, ceramic, glass, or plastic material.

10. The method of claim 7, wherein the material of the evacuable vessel comprises Gunnite.

11. The method of claim 7, wherein the gas impermeable layer is formed on both the interior surface and exterior surface of the evacuable vessel.

12. The method of claim 7, wherein the gas impermeable layer is comprised of an elastomer, metal, glass, plastic, or ceramic.

13. The method of claim 7, further comprising positioning the flywheel within the evacuable vessel on which the gas impermeable layer is formed and sealing the evacuable vessel and gas impermeable layer with the flywheel housed therein.

14. The method of claim 7, wherein the gas impermeable layer is formed by a plasma spraying means, a flame spraying means, a vapor deposition means, ion deposition means, powder coating, or powder fusing.

15. A method for enclosing a flywheel, the method comprising:
forming an evacuable vessel comprised of a material selected from the classes of materials comprising concrete;
forming a gas impermeable layer on at least one of an interior surface and an exterior surface of the evacuable vessel;
positioning the flywheel within an interior the evacuable vessel and the gas impermeable layer;
evacuating the interior of the evacuable vessel and the gas impermeable layer where the flywheel is housed to a desired pressure; and
sealing the gas impermeable layer so that the flywheel is housed within an interior with the desired pressure.

16. The method of claim 15, wherein the forming the evacuable vessel comprises forming a subunit of the concrete material on a removable mandrel, curing the subunit of the concrete material, and removing the removable mandrel.

17. The method of claim 15, wherein the material of the evacuable vessel comprises Gunnite.

18. The method of claim 15, wherein the gas impermeable layer is formed on both the interior surface and exterior surface of the evacuable vessel.

19. The method of claim 15, wherein the gas impermeable layer is comprised of an elastomer, metal, glass, plastic, or ceramic.

20. The method of claim 15, wherein the gas impermeable layer is formed by a plasma spraying means, a flame spraying means, a vapor deposition means, ion deposition means, powder coating, or powder fusing.
